(19) United States
(12) Patent Application Publication
(10) Pub. No.: US 2018/0320437 A1
(43) Pub. Date: Nov. 8, 2018

(54) SEALING UNIT FOR A SLIDING DOOR

(71) Applicant: Planet GDZ AG, Tagelswangen (CH)

(72) Inventor: Andreas DINTHEER, Illnau (CH)

(21) Appl. No.: 15/770,332

(22) PCT Filed: Oct. 23, 2016
(86) PCT No.: PCT/EP2016/075480

§ 371 Date: Apr. 23, 2018

(30) Foreign Application Priority Data
Oct. 23, 2015 (DE) 10 2015 118 174.6

(51) Int. Cl. E06B 7/215; E06B 3/46

(52) U.S. Cl. CPC E06B 7/215; E06B 3/4609

(57) ABSTRACT

A sealing unit for a sliding door has a lowering seal and a catch element (6). A mechanism (7, 4, 8) is designed to convert a sliding movement of a first sliding door element (T) relative to a second sliding door element (B) into a movement of a sealing strip arrangement (2, 3) that occurs substantially transversely to the sliding movement. The mechanism (7, 4, 8) has a rotatable or pivotable pick-up element (70) for picking up the sliding movement. In order to lower the seal, the pick-up element (70) lies on the catch element (6) in the lowering direction such that the weight force of the door thus assists the lowering operation.

### TECHNICAL FIELD

The present invention relates to a sealing unit for a sliding door.

### PRIOR ART

DE 20 2013 105 687 U1 describes a sealing apparatus in the form of a seal comprising a housing and at least one angle bracket for fastening the housing, and thus the seal, to a door leaf or similar, wherein the seal has at least one stop, by which the seal can be positioned in such a way that, in a state of the seal in which it is mounted on a door leaf, the housing of the seal does not protrude, or only slightly protrudes, beyond an edge of the groove. A triggering mechanism, which can be actuated via a pin protruding on the end side of the door leaf, is provided. Upon triggering, a sealing strip is advanced downward in order to seal off the lower door gap.

Furthermore, in market-available sealing apparatuses for sliding doors, automatic door seals for the top edge and the bottom edge are known in order thus to seal off the door gaps running horizontally in the direction of the sliding movement. The sliding door bottom seal is hitherto a normal lowerable bottom seal—for instance of the type known from DE 20 2013 105 687 U1—with additional lateral guide groove. In the guide groove runs the bottom guide pin, which is seated firmly on the floor and which guides the door laterally in its movement. The triggering of the bottom seal is realized on the end side with appropriate counterpressure upon the closure of the door. When the door is closed, this counterpressure must be permanently given (for example by magnets, motor, lateral clamping, or similar).

### REPRESENTATION OF THE INVENTION

An object of the invention is to provide an improved sealing unit at least for the bottom edge of a sliding door.

According to a first aspect, the invention provides a sealing apparatus for a sliding door for sealing off a door gap extending between a first sliding door element and a second sliding door element in the direction of relative movement of the sliding door elements, having a fastening device for fastening the sealing apparatus to the first sliding door element, a sealing strip assembly mounted movably relative to the fastening device, and a linkage mechanism, which is configured to convert a sliding movement of the first sliding door element relative to the second sliding door element into a movement, made substantially transversely to the sliding movement, of the sealing strip assembly relative to the fastening device, wherein the linkage mechanism has a pick-up element, which is rotatable or pivotable, in particular transversely to the sliding movement, for pick-up of the sliding movement.

The sealing unit according to the invention comprises the sealing apparatus and a catch element, which cooperates with the pick-up element. The pick-up element captures the catch element in the closing movement, more precisely the upwardly directed surface thereof, and rests on it, whereupon it thereby effects the lowering of the sealing strip assembly.

Preferably, the pick-up element is rotatably or pivotably mounted in such a way that it is movable transversely to the sliding movement. The sliding movement for the closure of the door defines the sliding direction.

It is preferred that the linkage mechanism has at least one lever for picking up a sliding movement between the first sliding door element and the second sliding door element.

It is preferred that the linkage mechanism has as the pick-up element a two-armed lever, which is preferably connected to the fastening device, in particular to the profile strip. When a catch element, preferably a projection, arranged close to a closing position on the second sliding door element is captured, one of the two levers, in the course of a closing movement of the sliding door, is movable in the direction toward the first sliding door element in order thus to move, i.e. lower, the sealing strip assembly by means of the other lever arm, preferably in combination with a lowering mechanism of the seal, toward the second sliding door element.

The catch element and the sealing apparatus form the sealing unit according to the invention.

It is preferred that the fastening device has a profile strip for fastening to the first sliding door element.

It is preferred that the sealing strip assembly is mounted on the fastening device displaceably in a direction transversely to the direction of relative movement of the sliding door elements, i.e. is lowerable and raisable.

It is preferred that the profile strip has a U-profile, within which the sealing strip assembly is movably accommodated.

According to a further aspect, the invention relates to a sliding door having a sealing apparatus according to one of the preceding designs.

It is preferred that the sliding door, as the first sliding door element, has a sliding door leaf, to which the fastening device is fastened.

It is preferred that the sliding door, as the second sliding door element, is a fixed unit, and that the catch element is configured close to the closing position. The catch element can be captured by the linkage mechanism close to the closing position so as to seal off the door gap by movement of the sealing strip assembly.

In the inventive triggering of the seal, the actual triggering force comes from the own door weight and/or from the moved mass as the door is closed.

In particular, by virtue of an advantageous design of the sealing apparatus, at least the bottom edge of a sliding door can be provided with a movable seal, which seals only in the closing state. In the movement of the door, no additional force expenditure is necessary and, depending on the design of the catch element, the restoring force of the seal can no longer automatically press on the closed or almost closed sliding door.

Through use of the here presented sealing apparatuses, in the closed state of the sliding door a good seal is attained without the sliding door having to be held in the closing position by separate measures and without the force requirement of the sliding door movement being increased, as would be the case, for example, in permanently acting seals. As a result, in particular in automatically driven sliding doors, savings can be made on energy for the drive.

The here represented solution can be easily integrated into existing sliding door ranges without any great need for modification. The sealing apparatus is usable both in sliding doors which run in front of a wall and in sliding doors which run in a wall.

Preferably, seals are also provided at the vertical door gaps of the sliding door. These vertical seals can be designed as has hitherto been customary.

In preferred embodiments, a sliding element which in the closed state is sealtight on four sides is achievable. In an advantageous design, no additional operating forces/retaining forces are necessary. In preferred embodiments, the sliding door is smoke-tight and fire-retardant. Advantageously, the sealing apparatus serves for sound damping purposes. In preferred embodiments, a sealing system with long service life is provided. In preferred embodiments, the sealing systems can be realized particularly easily in production engineering terms. In preferred embodiments, the sealing apparatus is configured such that it is usable in left/right arrangement. In preferred embodiments, the sealing apparatus is steplessly adjustable and shortenable.

Further embodiments are defined in the dependent claims.

### BRIEF DESCRIPTION OF THE DRAWINGS

Preferred embodiments of the invention are described below with reference to the drawings, which serve merely for illustrative purposes and should not be interpreted restrictively. In the drawings:

FIG. 1 shows an end view of a sliding door having a sealing unit according to a first embodiment of the invention;

FIG. 2 shows an end view of a sliding door having a sealing unit according to a second embodiment of the invention;

FIG. 3 shows a longitudinal section through the sealing unit according to FIG. 2;

FIG. 4 shows a perspective representation of a sealing unit in a third embodiment of the invention with raised sealing strip, and

FIG. 5 shows the sealing unit according to FIG. 4 with lower sealing strip.

### DESCRIPTION OF PREFERRED EMBODIMENTS

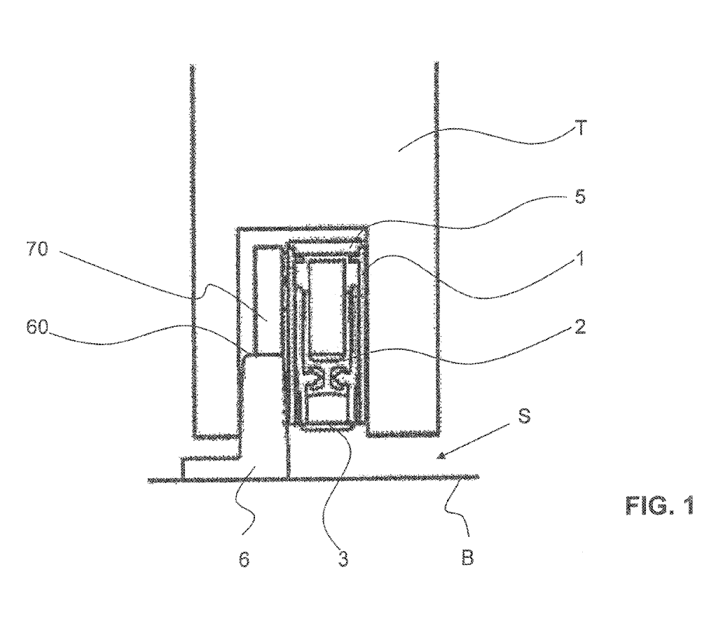

The illustrative embodiment according to FIG. 1 shows the basic principle of the invention. The explanations to this figure relate also to the other illustrative embodiments, where appropriate.

In FIG. 1, a sliding door having a first sliding door element T and a second sliding door element B are represented. The sliding door elements T, B are movable relative to each other in a sliding movement direction—perpendicular to the plane of the drawing in FIG. 1. The first sliding door element T is a preferably slidable leaf of the sliding door, the second sliding door element B is preferably the fixed frame of the sliding door or a floor of a building.

On the first sliding door element T is provided at least one sealing apparatus for sealing off a door gap extending in the sliding movement direction. In particular, the sealing apparatus is configured as an automatic door seal having a movable sealing strip assembly. Preferably, it is a mechanical drop-down seal which is automatically actuated upon the closure of the door.

In the represented embodiment, a first sealing apparatus for sealing off a door gap S is provided. In addition, a second sealing apparatus (not represented here) for sealing off a second door gap S can be provided. The second door gap is, for instance, an upper door gap, while the first door gap is, for instance, a lower door gap. The first sealing apparatus is thus configured, for instance, as an automatic floor seal.

The here described illustrative embodiments of the sealing apparatus can be used both as a first sealing apparatus for sealing off the lower, bottom door gap and as a sealing apparatus for sealing off the upper door gap.

As can be seen from FIG. 1, the sealing apparatus has a fastening device 1, 5, a sealing strip assembly 2, 3 mounted movably relative to the fastening device 1, 5 and having a sealing strip 3, also referred to as a sealing profile, and a sealing strip support 2, also referred to as a support rail, and further has a linkage mechanism having a pick-up element 70.

The linkage mechanism is configured to convert a sliding movement between the sliding door elements T, B, which sliding movement takes place before a closing position is reached, into a relative movement between fastening device 1, 5 and sealing strip assembly 2, 3 transversely to the sliding movement; i.e. to lower the sealing strip.

The linkage mechanism can here be differently configured. It can comprise for instance, but not restrictively, a transmission unit 7 and a lowering mechanism integrated in the sealing apparatus.

Depending on the embodiment, a part of the linkage mechanism, or of the transmission unit if present, is connected to another part of the sealing apparatus or hinged to another part of the sealing apparatus. The pick-up element 70 of the linkage mechanism can act, for instance, on a triggering button or a slide of the lowering mechanism. It can act, for instance, on an end side or on a longitudinal side on the lowering mechanism, or on another part of the sealing apparatus.

The pick-up element 70 of the linkage mechanism is movable, for pick-up of the sliding movement, transversely to the sliding movement. It is arranged, transversely to the sliding movement and, transversely to the pick-up movement of the pick-up element 30, laterally offset from the sealing strip assembly 2, 3, and is preferably hinged to the fastening device 1, 5. As is evident in FIG. 1, the pick-up takes place in the vertical direction, i.e. toward the floor or, to put it another way, parallel to the longitudinal surface and end face of the first sliding door element T. Hence the pick-up takes place in the direction of lowering of the sealing strip assembly 2, 3 and, in the case of bottom seals, in the direction of the weight force of the first sliding door element T.

The fastening device 1, 5 has, in particular, a profile strip 1, also referred to as a housing rail. In a preferred illustrative embodiment, the profile strip 1 is provided with a U-profile or is configured as such. The U-profile strip 1 serves as a housing for the sealing strip assembly 2, 3.

The housing is fastened with known means to the or in the first sliding element T. Usually, mounting brackets or angle brackets 5 which are fitted on the end side are used for this purpose. These are inserted with a first leg in a groove of the profile strip 1 and screwed, or otherwise fastened, with a second leg to the end face of the first sliding door element T.

The sealing strip assembly 2, 3 is movable on the fastening device 1, 5, in the direction of the first sliding door element T, toward the second sliding door element B, i.e. it can be lowered in relation to the housing rail 1. It can also be raised again in the opposite direction.

In particular, the sealing strip support 2 is held displaceably in the U-profile of the housing 1 such that the sealing strip 3 is movable transversely to the longitudinal direction of the profile strip 1 and parallel to the legs of the U-profile.

The linkage mechanism or the transmission unit 7 can be differently configured. For instance, it can comprise, as represented in FIG. 1, a lever. The lever is preferably hinged with a lever joint pivotably to the fastening device 1, 5. The lever, or a lever arm, picks up the sliding movement between the sliding door elements T, B and moves transversely to the sliding movement, and the linkage mechanism effects a lowering of the sealing strip assembly 2, 3.

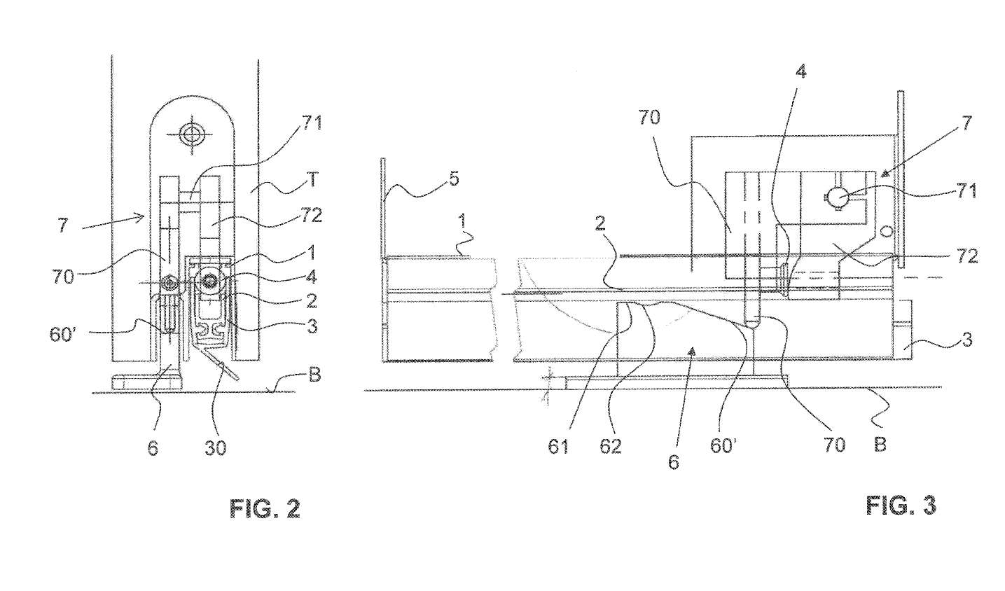

The conversion of the sliding movement of the sliding door into the lowering of the sealing strip assembly can be realized differently, as is described in greater detail below with reference to FIGS. 2 to 5.

As is evident in FIG. 1, the lever arm, here the pick-up element 70, projects in the vertical direction downward. On the second sliding door element B, an upwardly projecting catch element 6, also referred to as a run-up module, is present. The lever arm, i.e. the pick-up element 70, in this way serves to be captured by the catch element 6 on the second sliding door element B when the sliding door T moves into the vicinity of the opening position. For instance, the catch element 6 is a projection on the second sliding door element B.

The catch element and the sealing apparatus form the sealing unit according to the invention. The catch element can be manufactured and sold jointly with the sealing apparatus or jointly with the sliding door. The invention thus also comprises a sliding door having a sealing apparatus and a catch element, wherein the catch element is preferably arranged fixedly and preferably close to the closing position of the movable sliding door leaf.

The configuration of the catch element 6 and of the lever can be different. The pick-up element 70 can form the lever itself or can be, as the lever arm, part of the lever. Preferably, on the lever arm or on the pick-up element 70 is provided a pick-up surface, which, upon capturing of the catch element 6, achieves a pivoting of the lever in order to drive out the sealing strip assembly 2, 3 in the direction of the second sliding door element B. In FIG. 1, the catch element 6 has an upwardly directed catch surface 60 in order to capture the pick-up element 70 upon the closure of the sliding door. That is to say that the pick-up surface of the pick-up element 70 rests from above on the catch element 6, to be more precise on the catch surface 60. Preferably, the pick-up element 70, upon the closure of the door, slides along this catch surface 60, also referred to as bearing surface or run-up surface. “Up” should be understood according to the figures, i.e. “upwardly directed” is the opposite direction to the lowering of the seal and, in the event of bottom seals, the opposite direction to the weight force of the first sliding door element T.

The sliding strip assembly 2, 3 is preferably pretensioned in the opposite direction (i.e. to the lowering direction). To this end, a (non-represented) mechanical spring assembly, as is described, for instance, as part of the lowering mechanism later in the text, can be provided between the sealing strip assembly 2, 3 and the fastening device 1, 5.

In the represented examples, as the first sealing door element T is provided a sliding door leaf, while as the second sealing door element B is provided a fixed unit, for instance a fixed sliding door guide or a sliding door fitting or the floor.

The catch element 6 can, as represented, be a separate element sold together with the sealing apparatus, for arrangement on the fixed unit B in order thus to form the projection. Other arrangements and configurations are possible.

The catch element 6 is arranged fixed in such a way that, shortly before the closing position is reached, the projection acts on the lever arm or on the pick-up element 70. In the closing position of the sealing apparatus, where the sliding door leaf T has reached its closing position, the catch element 6 forces the lever arm or the pick-up element 70 in the direction of the sliding door leaf T, i.e. upward. As a result, the sealing strip assembly 2, 3 is lowered by means of the linkage mechanism.

Alternatively or additionally, a height-adjustable floor guide, in particular a height-adjustable catch element 6, can be provided.

In FIGS. 2 to 3, a further embodiment is represented. The sealing apparatus preferably corresponds to that already described above. The sealing strip 3 is here differently configured. Although it likewise has a substantially U-shaped cross section, it is additionally provided with a downwardly projecting sealing lip 30. The shape of the sealing strip is not, however, fundamental to the inventive idea, though the two sealing strips which are represented here, having the legs which project freely upward, have proved successful in practice.

Usually a lowering mechanism is arranged in the profile strip 1, wherein it lowers the sealing strip 3 in a under spring load and raises it by virtue of the spring restoring force. Mechanisms of this type are known in the prior art.

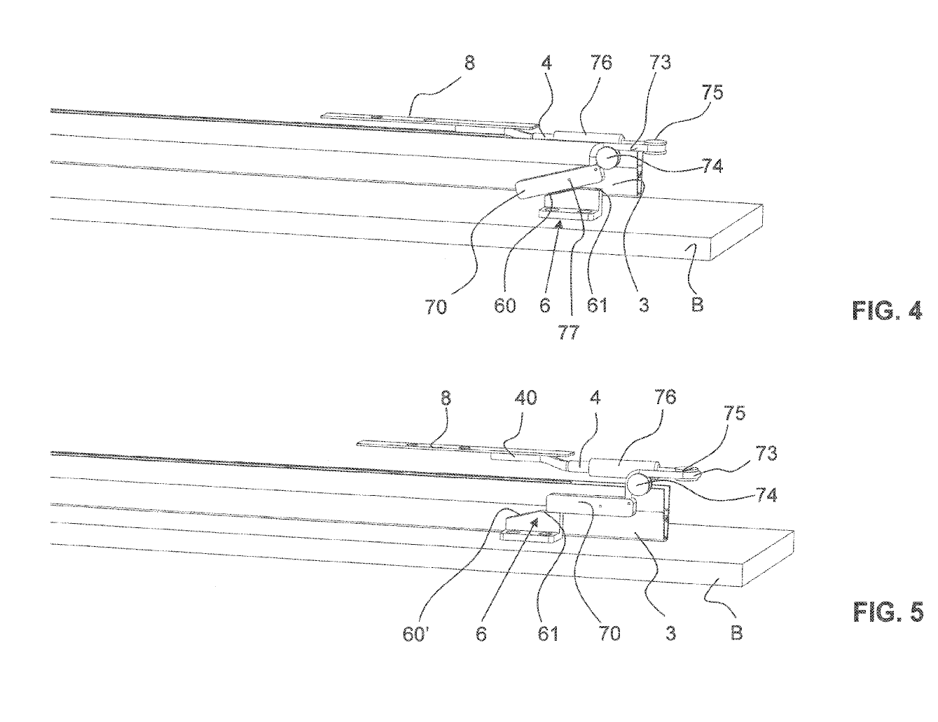

Leaf springs which extend over the length of the profile strip 1 have proved successful. The leaf springs are fastened with one end pivotably to the profile strip 1, in the middle region are connected to the sealing strip support 2 and, at the other end, are connected to a slide 8 (see FIG. 4) or an actuating rod. The slide 8 or the actuating rod extends in the longitudinal direction of the profile strip 1 and is connected to an actuating button 4 (see FIGS. 3 and 4), which is disposed on a face end of the profile strip 1. It can protrude from this same or be arranged set back therein. Upon the closure of the door, the actuating button 4 is pressed in, the springs are tensioned, and the sealing strip support 2 is lowered jointly with the sealing strip 3. When the door is opened, the actuating button 4 is released again and the springs are detensioned again. The sealing strip support 2 with the sealing strip 3 is automatically raised again. Other types of lowering mechanisms and triggers for the movement are possible.

The catch element 6, in turn, has an upwardly directed catch surface. The latter comprises in this example an sloping surface 60′, which rises in the closing direction of the sliding door and which passes preferably into a horizontal surface 61. The horizontal surface 60 preferably has a recess 62.

The pick-up element 70 is configured in the form of a downwardly directed lever or pin.

Upon closure of the first sliding door element T, the pick-up element 70 slides upward along the sloping surface 60′. The pick-up element 70 of the transmission unit 7 is forced upward, whereupon it thereby activates a mechanism of the transmission unit 7, which mechanism acts on the actuating button 4 of the lowering mechanism of the drop-down seal. The actuating button 4 is in this example preferably arranged set back in the profile rail 1. The transmission mechanism can be differently designed. Here a transmission element 71, for example in the form of a pivot lever, connected to the pick-up element 70, and an actuating element 72, for example likewise in the form of a pivot lever, connected to this transmission element 71, is represented schematically. The actuating element 72 acts with its free end on the actuating button 4, in that it presses this in, compresses the leaf springs of the lowering mechanism and thus lowers the sealing strip support 2 with the sealing strip 3.

The weight of the first sliding door element T is used for the lowering of the seal. Thus, for the closure of the sliding door, no substantial additional force has to be applied in order to lower the sealing strip.

The horizontal surface 60, in combination with the pick-up element 70 standing thereon, prevents that, when the sliding door is approximately or fully closed, the restoring force of the sealing apparatus reopens the sliding door. If, as represented here, a recess 61 is present, then an unintended opening of the sliding door is completely prevented.

In FIGS. 4 and 5, a further embodiment of the invention is represented. The catch element 6 has, in turn, an upwardly directed sloping surface 60′ and a, in the closing direction, following horizontal surface 61. The pick-up element 70 is a two-armed lever, which is pivotably fastened to the profile rail 1. The profile rail 1 is not represented. The pivot axis is denoted, however, by the reference symbol 77.

With a first arm, the lever, upon the closure of the sliding door, slides upward along the sloping surface 60′ up to the horizontal surface 61. The end of the second lever arm of the pick-up element 70 is connected with a cable 73 to the actuating button 4. For this, a first and a second deflection pulley 73, 74 are preferably present. The cable 73 ends preferably in a coupling sleeve 76, which can be detachably and adjustably connected to the actuating button 4. The actuating button 4 is in this example preferably arranged set back in the profile rail 1. In place of a cable 73, a cord, a band, a wire, or some other suitable elongate element can also be used. The term “cable” is used in this text and in the claims as an appropriate generic term for elements of this type.

As is evident in the combined view of FIGS. 4 and 5, the actuating button 4 is not pressed in but pulled out upon the closure of the sliding door. In the prior art it is known that seals can also be lowered by pulling instead of by pressing-in. This can be achieved, for instance, with the above-described drop-down seal, with leaf springs, in that one end is connected, instead of to the profile rail 1, to the slide 8 or the actuating bar 40, and the other end is connected to the profile rail 1. In short, the actuating button 4 is arranged at the other end of the seal. Here too, the triggering is realized without additional force expenditure by virtue of the weight force of the sliding door. Here too, an unwanted pressing on the closed or partially closed sliding door is prevented by the horizontal surface 61.

1-17. (canceled)

18. A sealing unit for a sliding door for sealing off a door gap extending between a first sliding door element and a second sliding door element in the direction of relative movement of the sliding door elements, having a sealing apparatus and a catch element, wherein the sealing apparatus has a fastening device for fastening the sealing apparatus to the first sliding door element, a sealing strip assembly mounted movably relative to the fastening device, and a linkage mechanism, which is configured to convert a sliding movement of the first sliding door element relative to the second sliding door element into a movement, made substantially transversely to the sliding movement, of the sealing strip assembly relative to the fastening device, wherein the linkage mechanism has a rotatable or pivotable pick-up element for the pick-up of the sliding movement, wherein the pick-up element, upon capturing of the catch element, drives out the sealing strip assembly in the direction of the second sliding door element and thus lowers this same, wherein the pick-up element, for the lowering of the sealing strip assembly in the drop-down direction of the sealing strip assembly, rests on the catch element.

19. The sealing unit as claimed in claim 18, wherein the linkage mechanism has as the pick-up element at least one lever for picking up a sliding movement between the first sliding door element and the second sliding door element.

20. The sealing unit as claimed in claim 18, wherein the fastening device has a U-shaped profile strip for fastening to the first sliding door element, and wherein the sealing strip assembly is mounted on the fastening device displaceably in a direction transversely to the direction of relative movement of the sliding door elements.

21. The sealing unit as claimed in claim 18, wherein the pick-up element is hinged, laterally offset from the sealing strip assembly, to the fastening device.

22. The sealing unit as claimed in claim 18, wherein the catch element is arranged fixedly, and the sealing apparatus displaceably, in the sliding door.

23. The sealing unit as claimed in claim 18, wherein the pick-up element is rotatable or pivotable transversely to the sliding movement.

24. The sealing unit as claimed in claim 18, wherein the catch element has an upwardly directed catch surface for the displaceable support, in the sliding direction, of the pick-up element.

25. The sealing unit as claimed in claim 24, wherein the catch surface runs in the sliding direction obliquely upward.

26. The sealing unit as claimed in claim 24, wherein the catch surface is at least in part a horizontal surface.

27. The sealing unit as claimed in claim 26, wherein a recess for the reception of the pick-up element is present in the horizontal surface.

28. The sealing unit as claimed in claim 18, wherein the linkage mechanism has a transmission unit, which acts on a lowering mechanism of the sealing apparatus.

29. The sealing unit as claimed in claim 28, wherein the lowering mechanism has a spring-loaded actuating button or a slide, which, by displacement in the longitudinal direction of the sealing apparatus, moves the sealing strip assembly transversely to the sliding movement, and wherein the transmission unit acts on this actuating button or on the slide.

30. The sealing unit as claimed in claim 29, wherein the pick-up element is a two-armed lever, which is pivotably fastened to the profile strip, and wherein a first arm of the lever, upon the closure of the sliding door, captures the catch element and wherein a second arm of the lever is connected to a cable which is connected to the lowering mechanism of the sealing apparatus and wherein the cable pulls on the actuating button.

31. The sealing unit as claimed in claim 30, wherein at least one deflection pulley for the deflection of the cable is present.

32. The sealing unit as claimed in claim 28, wherein the pick-up element is a two-armed lever, which is pivotably fastened to the profile strip, and wherein a first arm of the lever, upon the closure of the sliding door, captures the catch element and wherein a second arm of the lever is connected to a cable which is connected to the lowering mechanism of the sealing apparatus.

33. The sealing unit as claimed in claim 32, wherein at least one deflection pulley for the deflection of the cable is present.

34. The sealing unit as claimed in claim 18, wherein the pick-up element is a two-armed lever, which is pivotably fastened to the profile strip, and wherein a first arm of the lever, upon the closure of the sliding door, captures the catch element.

35. A sealing apparatus of a sealing unit for a sliding door for sealing off a door gap extending between a first sliding door element and a second sliding door element in the direction of relative movement of the sliding door elements, having a sealing apparatus and a catch element, wherein the sealing apparatus has a fastening device for fastening the sealing apparatus to the first sliding door element, a sealing strip assembly mounted movably relative to the fastening device, and a linkage mechanism, which is configured to convert a sliding movement of the first sliding door element relative to the second sliding door element into a movement, made substantially transversely to the sliding movement, of the sealing strip assembly relative to the fastening device, wherein the linkage mechanism has a rotatable or pivotable pick-up element for the pick-up of the sliding movement, wherein the pick-up element, upon capturing of the catch element, drives out the sealing strip assembly in the direction of the second sliding door element and thus lowers this same, wherein the pick-up element, for the lowering of the sealing strip assembly in the drop-down direction of the sealing strip assembly, rests on the catch element.
